(19) United States
(12) Patent Application Publication
(10) Pub. No.: US 2013/0194281 A1
(43) Pub. Date: Aug. 1, 2013

(54) Moisture Barrier for Electronic Devices

(71) Applicant: APPLE INC., Cupertino, CA (US)

(72) Inventors: Cheng Chen, San Jose, CA (US); Masato Kuwabara, Tsukuba (JP); Jun Qi, Cupertino, CA (US); Victor H. Yin, Cupertino, CA (US); John Z. Zhong, Cupertino, CA (US); Wei Chen, Palo Alto, CA (US)

(73) Assignee: APPLE INC., Cupertino, CA (US)

(21) Appl. No.: 13/690,556

(22) Filed: Nov. 30, 2012

Related U.S. Application Data
(60) Provisional application No. 61/592,578, filed on Jan. 30, 2012.

(51) Int. Cl. G02B 27/00; G06F 1/00; G02F 1/1335

(52) U.S. Cl. CPC G02B 27/0006; G02F 1/133536; G06F 1/00
USPC 345/501; 359/491.01; 359/485.01; 349/96

(57) ABSTRACT

An electronic display configured to provide a visual output, such as a liquid crystal display. The electronic display includes an optical shutter and a first polarizer operably connected to the optical shutter. The first polarizer includes an optical filter layer, a protective layer, and a moisture barrier positioned on a first surface of either the optical filter or the protective layer. The moisture barrier substantially prevents water molecules from being transmitted therethrough.

### CROSS REFERENCE TO RELATED APPLICATIONS

This application claims the benefit of priority pursuant to 35 U.S.C. §119(e) of U.S. provisional application No. 61/592,578 filed 30 Jan. 2012 entitled “Moisture Barrier for Electronic Displays,” which is hereby incorporated herein by reference in its entirety.

### TECHNICAL FIELD

The present invention relates generally to electronic devices, and more specifically to graphical displays for electronic devices.

### BACKGROUND

Display screens, which may be integrated or separate from electronic devices, may provide graphical output (and input in some cases) for electronic devices. These displays may include a glass or transparent plastic covering a light transmitting layer. For example, liquid crystal displays (LCD) operate by backlight a layer of liquid crystal arranged in an optical matrix. The liquid crystals change orientation based on an electrical current. As the crystals are re-oriented, they align with different color filters to vary the colors displayed at each pixel of the display. The display may also include a polarizer to block light having a predetermined polarization transmitted through or into the liquid crystals. However, moisture may seep into and out of the polarizer, which may include one more layers. As moisture seeps into or out of the polarizer, one or more layers of the polarizer may change in shape or dimension, which may affect the shape and/or dimension of the display. For example, as the display bows or bends, spaces or gaps may be created between the display and an enclosure of the display. These spaces or gaps may allow light, for example, from side-firing or other backlights, to escape around the edges of the display. Additionally, the bowing or bending of the display may cause concentrated stresses at attachment points of the display and enclosure, which may lead to cracks or mechanical failure.

### SUMMARY

Examples of embodiments described herein may take the form of an electronic display configured to provide a visual output. The electronic display includes an optical shutter such as a light transmitting layer configured to transmit at least one color of light and a first polarizer operably connected to the optical shutter. The first polarizer includes an optical filter layer, a protective layer and a moisture barrier positioned on a first surface of either the optical filter or the protective layer.

Other examples of embodiments described herein may take the form of a mobile electronic device. The electronic device may include a processor configured to receive and execute instructions and a display in communication with the processor and configured to provide a visual output. The display includes a transmitting layer and at least one polarizer. The at least one polarizer includes a triacetyl cellulose layer, polyvinyl alcohol layer, and a water impermeable layer positioned on at least one surface of the tri acetyl cellulose layer or the polyvinyl alcohol layer.

Yet other examples of embodiments described herein may take the form of an electronic display configured to provide a visual output. The electronic display may include an optical shutter and a polarizer operably connected to the optical shutter. The polarizer may include an optical filter layer, a protective layer, a reflective polarizer film, and a moisture barrier positioned on a first surface of either the optical filter, the protective layer, or the reflective polarizer film.

### BRIEF DESCRIPTION OF THE DRAWINGS

FIG. 1 is a perspective view of an electronic device including a display.

FIG. 2 is a cross-section of the electronic device taken along line 2-2 in FIG. 1.

FIG. 3 is an enlarged view of the cross-section of the display of FIG. 2.

FIG. 4 is an enlarged view of a polarizer of the display of FIG. 3.

FIG. 5 is a cross-section view of the a tri acetyl cellulose layer of the display of FIG. 4, illustrating water molecules penetrating therethrough.

FIG. 6A is a cross-sectional view of the display including the polarizer of FIG. 4 with moisture being absorbed by a poly vinyl alcohol layer.

FIG. 6B is a cross-sectional view of the display including the polarizer of FIG. 4 with moisture seeping from the poly vinyl alcohol layer.

FIG. 7A is an enlarged cross-section view of a polarizer including a moisture barrier or layer.

FIG. 7B is another example of an enlarged cross-section view of a polarizer including a moisture barrier.

FIG. 8 is an enlarged cross-section view of the polarizer of FIG. 7A including a second moisture barrier.

FIG. 9 is an enlarged cross-section view of the tri acetyl layer and the moisture barrier preventing water from penetrating past the tri acetyl layer.

FIG. 10 is a simplified cross-section view of the second polarizer including the moisture barrier.

### SPECIFICATION

This disclosure relates generally to a display including a moisture barrier or layer to prevent moisture seepage between one or more components or layers of the display. The display may provide output and/or input functions for an electronic device, such as a smart phone, tablet, laptop, desktop computer, or the like. For example, the display may present a graphical user interface, show text, images, video, and the like, as well as display other types of visual output. Additionally, the display may include one more sensors for providing input, such a capacitive grid or infrared grid to sense capacitive, resistive, and/or proximal inputs.

In some embodiments, the display may include one or more light polarizers, two or more substrates, and a transmitting layer for producing light. One or both of the polarizers may include a protective layer such as a triacetyl cellulose (TAC) layer, an optical filter such as a polyvinyl Alcohol (PVA) layer, one or more retarders, and one or more adhesives, such as pressure sensitive adhesive (PSA), that secures other layers together. The polarizer also includes a moisture barrier or blocking layer, such as a water impermeable material or component. The moisture barrier may be a separate layer or component, or the moisture barrier may be incorporated into one of the other layers of the display stack. The moisture barrier may substantially prevent moisture from seeping into or out of select layers or portions of the display. For example, the moisture barrier may be positioned over, under, nearby, or adjacent, at least a portion of the PVA layer to prevent moisture from escaping from the PVA layer or entering into the PVA layer. In other embodiments, the moisture barrier may be positioned over one or more of the layers above the PVA layer, such as above the TAC layer, which may be positioned above the PVA layer within the stack of the polarizer.

As the moisture barrier may be substantially impermeable to fluids such as water, it may prevent moisture from penetrating one or more of the layers of the display. This may substantially prevent one or more layers of the display from warping or otherwise changing dimension or shape due to moisture changes such as increases or decreases in humidity. This is because the PVA layer (or other optical filter) may change in shape or dimension as it absorbs or releases moisture. The moisture barrier may thus cause the moisture level within the display stack, for at least the PVA layer, to remain substantially constant, even as the outside environment varies. Thus, in a humid environment the moisture level within the PVA layer of the display stack may be substantially the same as the moisture level in a desert or dry environment. The moisture barrier may help the display in providing relatively consistent performance across different environments, as well as help to ensure that at least one of the dimensions of the various layers of the display may remain substantially constant, regardless of the outer environment of the display.

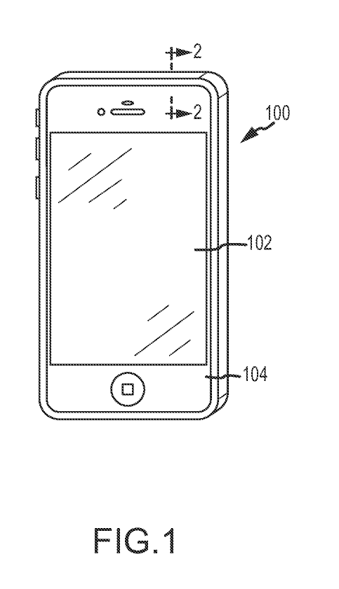

Turning now to the figures, FIG. 1 is a perspective view of an electronic device 100 including a display 102 and an enclosure 104 surrounding at least a portion of the display 102. As shown in FIG. 1, the display 102 may be integrated into the electronic device 100. However, in other embodiments, the display 102 may be separate from the electronic device 100, taking the form of a stand-alone computer monitor, television display, or the like. The enclosure 104 may secure at least a portion of the display 102 to the device 100 and may extend around an outer perimeter edge of the display 102. In other embodiments, the display 102 may be substantially flush with an edge of the enclosure 104 or positioned over a portion of the enclosure 104. Although not shown, the display 102 may be in communication with one or more components of a typical electronic or computing device, such as a processor, to provide output and/input for the device 100.

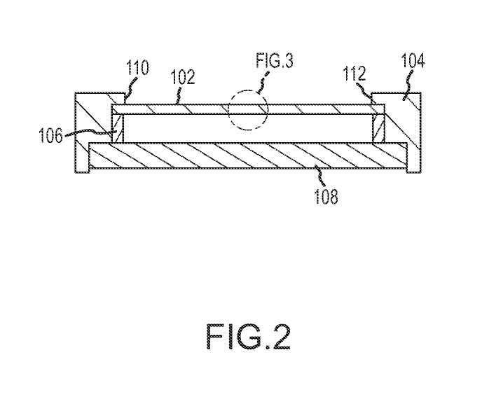

In some embodiments, adhesive, glue, or other fastening members may be used to secure the display 102 to the enclosure 104. FIG. 2 is a cross-section of the display 102 taken along line 2-2 in FIG. 1. As shown in FIG. 2, the display 102 may be operably connected to a base or substrate 108 by fastening members 106. The fastening members 106, which may be adhesive, may be positioned on a bottom surface of the display 102 and may contact the outer surface of the substrate 108. The substrate 108 may also provide electrical connections for components of the display 102 to a processor, such as one or more transistors, electrodes, or other drive circuitry to vary the colors and output of the display 102.

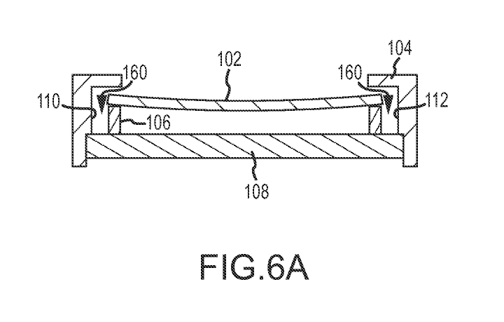

In some embodiments, the display 102 may span between two inner edges 110, 112 of the enclosure 104. The display 102 may be configured to be in contact with the inner edges 110, 112 of the enclosure so that there may be little or no space between the inner edges 110, 112 of the enclosure 104 and the display edge 102. In other words, the edges of the display 102 may be substantially flush with the inner edges 110, 112 of the enclosure 104. This type of positioning may prevent light from leaking around edges of the display 102, helping to ensure that the only light emitted from the electronic device 100 may be emitted through the display 102. However, as discussed in more detail below with respect to FIGS. 6A and 6B, water or other fluids may affect the display 102 shape and/or connection to the enclosure 104, and light may leak around the edges of the display 102.

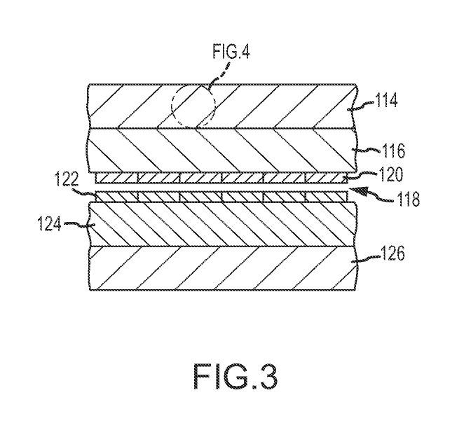

The display 102 may include multiple layers arranged in a stack. FIG. 3 is an enlarged cross-sectional view of a portion of the display 102. The display 102 may include a first polarizer 114, a filter substrate 116, a transmitting layer 118, a transistor substrate 124, and a rear polarizer 126. In some embodiments, the display 102 may also include a indium tin oxide (ITO) or other sensor mechanism for capacitive or other sensing.

In some embodiments, the transmitting layer 118 may have a liquid crystal layer, an optical shutter, or another light characteristic varying sub-layer, one or more color filters 102, and drive members or transistors 122. The transistors 122 may be thin film transistors (TFT) or other switching members and may change the orientation or alignment of the liquid crystals by varying an electrical current applied thereto. As the liquid crystals are re-oriented they may be aligned with a different color filter 120, so that as light is transmitted (e.g., from a backlight) through the light transmitting layer 118 the color of the light may vary as the liquid crystals vary in alignment. For example, a backlight (not shown) may transmit a white light through the display 102, and the orientation of the light crystals (and thus alignment with a particular color filter) may determine the color output for a particular pixel of the display 102.

The filter substrate 116 and the transistor substrate 124 may support the color filters 120 and the transistors 122, respectively. Each the filter substrate 116 and the transistor substrate 124 may be transparent to allow light to be transmitted into and out of the transmitting layer 118. Accordingly, in some embodiments, the filter substrate 116 and the transistor substrate 124 may be glass, plastic, or other similar transparent materials.

The first and second polarizers 114, 126 may selectively block light, based on the polarization of that light. Specifically, the first polarizer 114 may be positioned on a front of the display 102 and may block light transmitted with a predetermined polarization transmitted from the transmitting layer 118 from being transmitted out of the display 102, and the second polarizer 126 may be positioned on a back or rear of the display 106 and block light transmitted with a predetermined polarization from being transmitted into the transmitting layer 118.

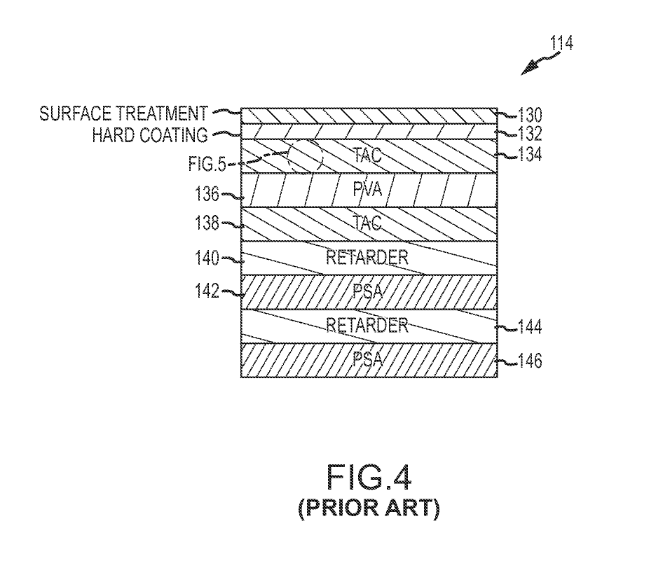

Each polarizer 114, 126 may include one or more sub-layers. FIG. 4 is an enlarged view of the cross-section view of FIG. 3 illustrating conventional layers of the first polarizer 114. Although FIG. 4 illustrates the layers of the first polarizer 114, it should be noted that, in some embodiments, the second polarizer 126 may be substantially identical. As shown in FIG. 4, in some typical LCD panels, the first polarizer 114 may include a surface treatment layer 130, a coating layer 132, a first protective layer such as a first TAC layer 134, an optical filter such as a PVA layer 136, a second protective layer such as a second TAC layer 138, a first retarder 140, a first adhesive member 142, a second retarder 144, and/or a second adhesive member 142.

The surface treatment layer 130 may be a coating such as an anti-glare and/or an anti-reflection coating to minimize glare and/or reflection from the display 102. In these instances, the surface treatment layer 130 may be applied as a thin coating to the first polarizer 114. The coating layer 132 may be combined with the surface treatment layer 130 or may be separate therefrom. In some instances, the coating layer 132 may be a hard coating that may help to maintain the chemical composition of the polarizer 114, as well as may help to reduce scratches or the like from damaging the polarizer 114, as the polarizer may form the outer surface of the display 102.

The first and second protective layers or TAC layers 134, 138 may be positioned on either side of the PVA layer 136. The TAC layers 134, 138 may form protective layers for the PVA layer 136, as the PVA layer 136 may be fragile and/or dimensionally unstable. The TAC layers 134, 138 may assist in maintaining the dimensions of the PVA layer 136, as well as prevent the PVA layer 136 from cracking or the like. It should be noted that other materials other than TAC may be used as protective layers for the PVA layer 136. For example, other cellulose polymers, ester polymers such as polyethylene terephthalate (PET), polyethylene naphthalate (PEN), olefinic polymers such as cyclo-olefin polymer (COP), amorphous polyolefin such as polypropylene (PP) and polypropylene (PE), or the like, may be used in place of TAC.

The PVA layer 136, which is a polarized optical filter, may be a polarizing dichroic film or may otherwise include a dichroic dye. For example, the PVA layer 136 may be a directional optical filter to selectively block light with predetermined polarizations. As briefly described above, the PVA layer 136 may be stretched to form a thin film and as such may be relative fragile and/or dimensionally unstable. Thus, the PVA layer 136 may be sandwiched between the two TAC layers 134, 136, which provide structure and protection.

The first retarder layer 140 may be operably connected to a bottom surface of the second TAC layer 138. The second retarder layer 144 may be operably connected to the first retarder 140 by the first adhesive member 142. The retarders 140, 144 may retard certain wavelengths of light at predetermined angles and/or directions. In this manner, the retarders 140, 144 may compensate and/or improve the oblique angle quality of the display 102.

The first adhesive member 142 may interconnect the first retarder 140 to the second retarder 144. The second adhesive member 146 may interconnect the second retarder 140 to the filter substrate 116, or in the case of the second polarizer 126, may connect to the substrate 108. The adhesive members 142, 146 may be positioned at discrete locations within their respective layers (e.g., at the corners of the preceding layer) or may form their own layer within the stack. In some embodiments, the adhesive members 142, 146 may be layers of pressure sensitive adhesive (PSA) or other similar adhesive.

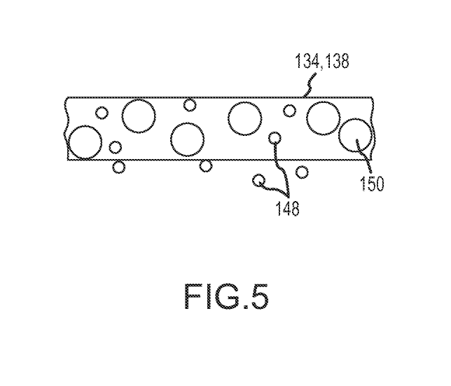

With respect to the polarizer 114 as shown in FIG. 4, moisture may be able to permeate the one or more layers of the stack. FIG. 5 is a cross-section view of the first TAC layer 134 illustrating water molecules 148 penetrating between the dispersion of the TAC molecules 150. This is possible as the TAC molecules 150 may generally be dispersed in a scattered or sparse manner. Additionally, TAC may be at least somewhat hydrophilic, and water and other fluids may be able to penetrate into the TAC material rather easily.

As moisture may travel into and through the TAC layers 134, 138, fluids such as water may enter into the PVA layer 136. As described above, the PVA layer 136 may be somewhat dimensionally unstable and when additional moisture is absorbed or released, the PVA layer 136 may change shape and/or dimension. For example, the PVA layer 136 may bow or bend, see, for example, FIGS. 6A and 6B. Further, PVA may easily absorb and/or release moisture depending on the outer environment (e.g., in humid or dry environments).

As the PVA layer 136 absorbs moisture, it may change in shape and/or in one or more dimensions. FIG. 6A is a cross-sectional view of the display 106 including the first polarizer 114 shown in FIG. 4 with moisture being absorbed therein. As shown in FIG. 6A, as moisture enters into the PVA layer 136, the PVA layer 136 may expand or stretch, which may change the overall dimension of the display 102. This may cause the display 102 to bow upwards away from the substrate 108. As the display 102 bows, one or more spaces 160 may be created between the edges of the display 102 and the inner edges 110, 112 of the enclosure 104. These spaces 160 may allow light, such as light from a backlight (not shown), to leak around the edges of the display 102. The light leakage may affect the appearance of images on the display 102, as well as possibly creating a halo effect around at least a portion of or all of the display 102. For example, the leaked light may be white light, which may contrast with the color-filtered light emitted through the display 102.

Just as moisture may enter and be absorbed, moisture may escape from the PVA layer 136. FIG. 6B is a cross-sectional view of a display 102 having a first polarizer 114 showing moisture exiting the PVA layer 136. As shown in FIG. 6B, as moisture may penetrate through the TAC layers 134, 138 from the PVA layer 136, the PVA layer 136 may shrink or otherwise change in dimension or shape. As an example, if the display 102 is exposed to a dry environment, water or other fluids within the PVA layer 136 may evaporate therefrom. This evaporation may cause the PVA layer 136 to shrink or otherwise change in shape or dimension, as one example, the PVA layer 136 may warp inward.

As the display 102 is secured to the substrate 108 by the fastening members 106, with changes in the shape or dimensions of the display 102 (that is, the PVA layer 136), the strain in the display 102 may be concentrated at the point of contact with the fastening members 106. This increased strain may increase the likelihood of mechanical failure of the display 102 and/or cracks within the display 102. Further, as with the display 102 in FIG. 6A, as the PVA layer 136 changes dimension and/or shape, one or more spaces 162 may be defined between the inner edges 110, 112 of the enclosure 104 and the outer edge of the display 102. Similarly to FIG. 6A, the spaces 162 may allow light to escape around from the device 100 around the display 102, affecting the overall appearance of the display 102.

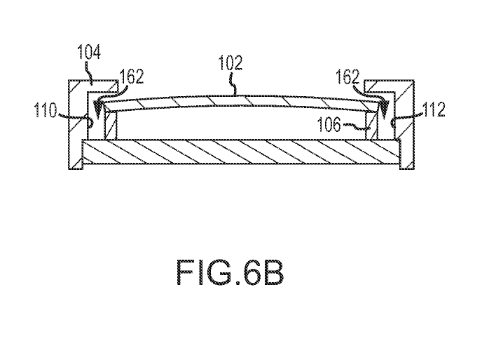

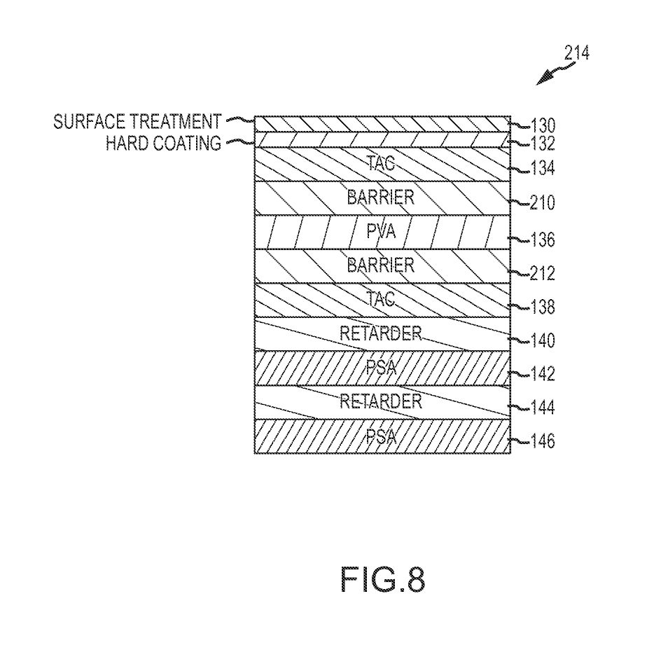

In order to prevent the PVA layer 136 from becoming misshapen due to moisture absorption or moisture loss, a moisture barrier layer may substantially prevent moisture from entering or exiting the PVA layer 136. FIG. 7A is an enlarged cross-section view of a polarizer 214 including one more moisture barriers 210 or layers. As shown in FIG. 7A, the moisture barrier 210 may be positioned between a first protective layer (such as a first TAC layer 134) and the optical filter (such as the PVA layer 136). FIG. 9 is an enlarged cross-section view of TAC layer 134 and the moisture barrier 210. As shown in FIG. 9, the moisture barrier 210 may include a dense arrangement of molecules 168, which may substantially prevent the water molecules 148 that enter the TAC layer 134 from being transmitted out the bottom surface of the TAC layer 134. Additionally, the dense molecular arrangement of the moisture barrier 210 may prevent any water molecules 148 beneath the moisture barrier 210 from being transmitted into the TAC layer 134.

The moisture barrier 210 may be separate from the TAC layer 134, coated onto the TAC layer 134, or mixed into the TAC layer 134. The moisture barrier 210 may be positioned on an inner or outer surface of the TAC layer 134. FIG. 7B is an enlarged cross-section view of a polarizer 214 including the moisture barrier 210 positioned on an outer surface of the TAC layer 134. With reference to FIG. 7B, the moisture barrier 210 may be positioned between the TAC layer 134 and the hard coating 132 (or outer surface of the polarizer 214) or with reference to FIG. 7A may be positioned between the TAC layer 134 and the PVA layer 136. Additionally, the moisture barrier 210 may be positioned on a top and/or bottom of the PVA layer 136 as well. However, in embodiments where the moisture barrier 210 is positioned on a top surface of the first TAC layer 134, such as shown in FIG. 7B, the moisture barrier 210 may be better able to prevent moisture from seeping into the PVA layer 136. This is because the moisture barrier 210 may prevent moisture from entering into the TAC layer 134 completely, and not just prevent moisture from entering into the PVA layer 136 from the TAC layer 134. In embodiments, where the moisture barrier 210 is positioned on an inner surface of the first TAC layer 134, (adjacent the PAC layer 136), the moisture barrier 210 may be better protected from damage or removal.

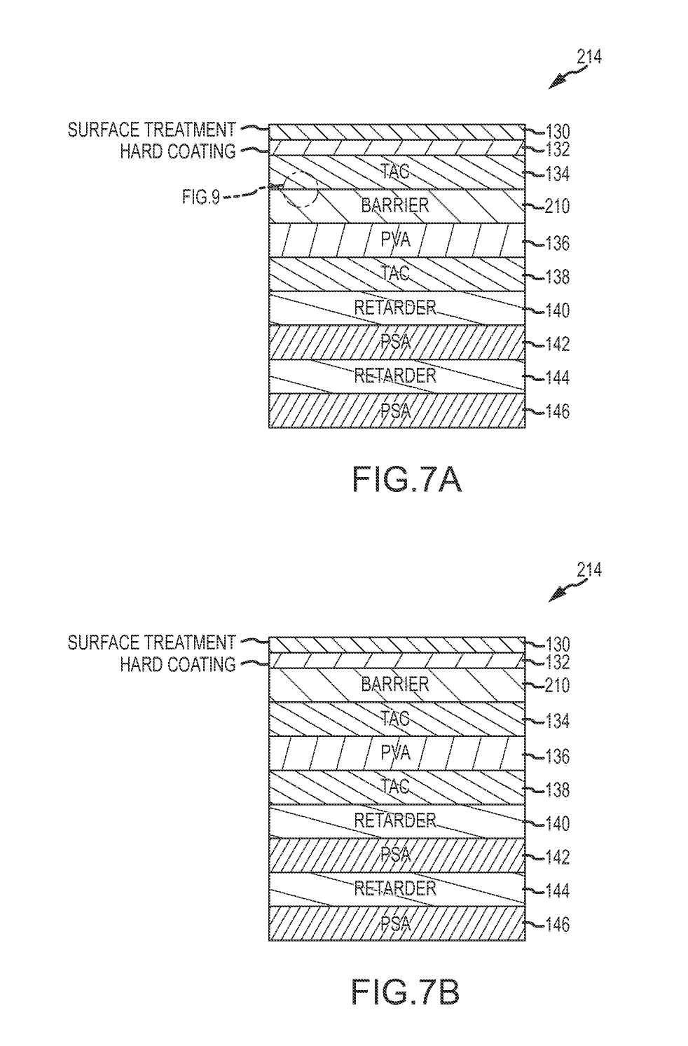

In some embodiments, the polarizer 214 may include a second moisture barrier. FIG. 8 is a cross-sectional view of the polarizer 214 having a first moisture barrier 210 and a second moisture barrier 212. In this embodiment, the moisture barriers 210, 212 may sandwich the PVA layer 136. Stated in another way, each the front surface and the rear surface of the PVA layer 136 may be in contact with the moisture barriers 210, 212, which then may be in contact with the respective TAC layer 134, 138.

Furthermore, in some embodiments, the moisture barriers 210, 212 may be combined with the surface treatment layer 130 and/or the hard coating layer 132. In these embodiments, the thickness of the polarizer 214 stack may remain substantially the same, while providing the functionality of the moisture barrier 210, 212.

It should be noted that although FIGS. 7A and 8 are discussed with reference to the first polarizer 214, in some embodiments, the moisture barriers 210, 212 may be integrated within the second or rear polarizer of the display 102. In these embodiments, the second polarizer, which may be positioned beneath the transmission layer 118, may be substantially the same as illustrated in FIGS. 7A and 8. Also, in some embodiments, both the front and rear polarizer may include the moisture barrier 210, 212. However, it should be noted that in some instances, only the first or front polarizer 214 may need the moisture barriers 210, 212 as the rear or second polarizer 126 may be further removed from moisture. This is because the rear polarizer may be positioned underneath more layers within the display 102 stack, and thus as long as moisture barrier 210, 212 is positioned above the first polarizer it may substantially prevent moisture from being transmitted to the second polarizer. That said, in some applications it may be desirable to include a moisture barrier on the second polarizer. For example, the moisture barrier may prevent moisture from seeping into or out of the second polarizer, which may help to prevent the two polarizers from becoming unbalanced from each other.

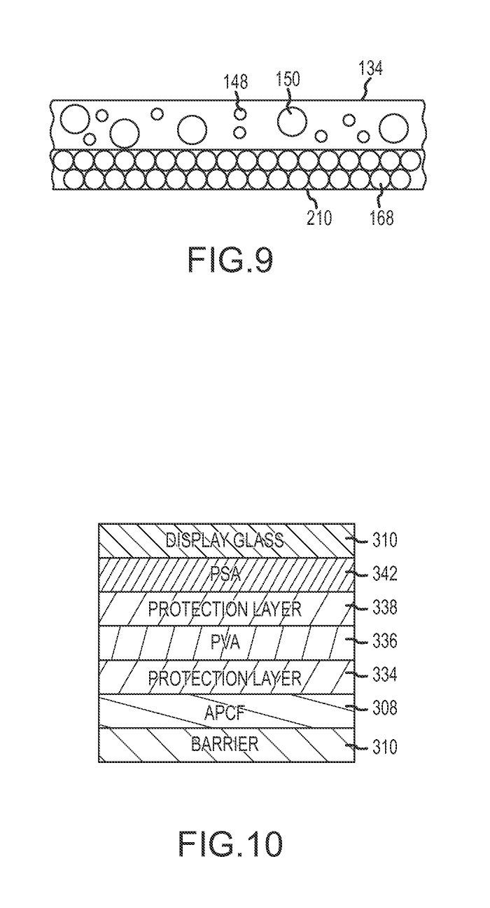

As one example, the rear polarizer may include a moisture barrier as a bottom layer. FIG. 10 is a simplified cross-section view of the second polarizer including the moisture barrier. With reference to FIGS. 3 and 10, the second polarizer may be positioned below the substrate 124 or display glass 310 and the moisture barrier may be positioned on the bottom of the second polarizer. In some instances, the moisture barrier on the first polarizer may be sufficient to prevent moisture from seeping in or out of the stack. However, in some instances, moisture may seep into the second polarizer from the bottom, and so the two polarizers could become unbalanced without the additional of the moisture barrier to the second polarizer. Accordingly, as shown in FIG. 10 the moisture barrier 310 may be added to the second polarizer.

With reference to FIG. 10, the protection layers 334, 338, the PVA 336, and the PSA layers may be substantially similar to the TAC layers 134, 138, PSA layers 142, 146, and PVA layer 136 illustrated in FIGS. 7A, 7B, and 8, respectively. However, as shown in FIG. 10, the protection layers 334, 338 may be either a supporting layer (such as a TAC layer), or may be a retardation layer. It should be noted that the type of material for the protection layer may depend on the particular application of the polarizer.

Additionally, as shown in FIG. 10, in some embodiments, the moisture barrier 310 may be positioned over a reflective polarizer 308. The reflective polarizer 308 may enhance optical efficiency. For example, the reflective polarizer 308 may be the a reflective polarizer film such as Advanced Polarizer Film (APF), Advanced Polarizer Controlled Film (APCF), or Dual Brightness Enhancement Film (DBEF) made by 3M.

In some embodiments, the moisture barriers 210, 212, 310 may be transparent inorganic materials that have an optical transmittance equal to or greater than 85%. In some embodiments, the optical transmittance may be equal to or greater than 90%. Additionally, the moisture barriers 210, 212, 310 may have a water permeability or water transmittance characteristic that may range between ten grams per square meter per day per atmospheric pressure to one gram per square meter per day at atmospheric pressure. However, these values are for illustrative purposes only, and other values are envisioned.

In some embodiments, the moisture barriers 210, 212, 310 may be silicon oxide (SiO, SiO₂, SiOₓ) or aluminum oxide (Al₂O₃, AlOₓ). The “x” provided for the oxygen component for silicon oxide and aluminum oxide is meant to indicate that the “x” may be an arbitrary number for the oxidation state of the base layer. In other embodiments, the moisture barriers 210, 212 may be magnesium oxide, sodium oxide, or oxides of metals in Periods 3 and 4 of the periodic table. In yet other embodiments, the moisture barrier 210, 212, 310 may be a clay material, or a mixture containing clay components. Also, in embodiments including the second barrier 212, the first moisture barrier 210 may be the same as or different from the second moisture barrier 212, 310. For example, the first moisture barrier 210 may be silicon oxide whereas the second moisture barrier 212 may be aluminum oxide. However, in other embodiments, the two moisture barriers 210, 212 may be substantially the same.

The moisture barrier(s) 210, 212, 310 may be applied as a separate layer, may be a coating for one of the other layers, or may be combined with one of the layers of polarizer 214. For example, the moisture barriers 210, 212, 310 may be vacuum deposited on the TAC layer(s) 134, 138, may be sprayed onto the TAC layer(s) 134, 138, or may be applied by a wet coating by water based solvents or other solvent types.

In some embodiments, the moisture barrier 210, 212, 310 may be applied across the entire length and width of the TAC layer(s) 134, 138. However, in other embodiments, the moisture barrier 210, 212 may only be applied along a portion of the length and/or width. In some instances, moisture may be positioned on only a portion of the TAC layer(s) 134, 138.

### Conclusion

The foregoing description has broad application. For example, while examples disclosed herein may focus on displays for electronic devices, it should be appreciated that the concepts disclosed herein may equally apply to polarizers used in other applications. Similarly, although the moisture barrier may be discussed with respect to PVA, the techniques disclosed herein are equally applicable to other resin films or filters. Accordingly, the discussion of any embodiment is meant only to be an example and is not intended to suggest that the scope of the disclosure, including the claims, is limited to these examples.

What is claimed is:

1. An electronic display configured to provide a visual output comprising:
an optical shutter; and
a first polarizer operably connected to the optical shutter comprising:
an optical filter layer;
a protective layer; and
a moisture barrier positioned on a first surface of either the optical filter or the protective layer.

2. The electronic display of claim 1, wherein the optical filter is polyvinyl alcohol.

3. The electronic display of claim 1, wherein the protective layer is tri-acetyl cellulose.

4. The electronic display of claim 1, wherein the protective layer further comprises a first protective layer and a second protective layer and the optical filter is positioned between the first protective layer and the second protective layer.

5. The electronic display of claim 4, wherein the moisture barrier is positioned between the first protective layer and optical filter.

6. The electronic display of claim 4, wherein the moisture barrier is positioned between the second protective layer and the optical filter.

7. The electronic display of claim 4, wherein the moisture barrier is positioned on the first protective layer on a side opposite of the optical filter.

8. The electronic device of claim 1, wherein the moisture barrier is an inorganic material.

9. The electronic device of claim 1, wherein the moisture barrier has an optical transmittance greater than eighty percent.

10. The electronic device of claim 1, wherein the moisture barrier has a permeability less than ten grams per square meter per day per atmospheric pressure.

11. The electronic device of claim 10, wherein the permeability is less than one gram per square meter per day per atmospheric pressure.

12. The electronic device of claim 1, further comprising a second polarizer including a second optical filter and a second protective layer.

13. The electronic device of claim 12, wherein the second polarizer further comprises a second moisture barrier configured to substantially prevent moisture from entering into or leaving the second protective layer.

14. An mobile electronic device comprising:
a processor configured to receive and execute instructions; and
a display in communication with the processor and configured to provide a visual output, the display comprising:
a transmitting layer; and
at least one polarizer including
a tri acetyl cellulose layer;
a poly vinyl alcohol layer; and
a water impermeable layer positioned on at least one surface of the tri acetyl cellulose layer or the poly vinyl alcohol layer.

15. The mobile electronic device of claim 14, wherein the water impermeable layer has a permeability less than ten grams per square meter per day per atmospheric pressure.

16. The mobile electronic device of claim 14, wherein the permeability is less than one gram per square meter per day per atmospheric pressure.

17. An electronic display configured to provide a visual output comprising:
an optical shutter; and
a polarizer operably connected to the optical shutter comprising:
an optical filter layer;
a protective layer;
a reflective polarizer film; and
a moisture barrier positioned on a first surface of either the optical filter, the protective layer, or the reflective polarizer film.

18. The electronic display of claim 17, wherein the moisture barrier is positioned on the reflective polarizer film.

19. The electronic display of claim 17, wherein the optical shutter is a liquid crystal layer.

20. The electronic display of claim 17, wherein the moisture barrier substantially prevents water molecules from being transmitted therethrough.
